(19) United States
(12) Patent Application Publication
(10) Pub. No.: US 2025/0287478 A1
(43) Pub. Date: Sep. 11, 2025

(54) HEATING COOKER

(71) Applicant: SHARP KABUSHIKI KAISHA, Sakai City (JP)

(72) Inventors: YU SHINOHARA, Sakai City (JP); Nobuo TAKEMOTO, Sakai City (JP)

(21) Appl. No.: 19/021,795

(22) Filed: Jan. 15, 2025

(30) Foreign Application Priority Data
Mar. 8, 2024 (JP) 2024-036056

(51) Int. Cl. H05B 6/64

(52) U.S. Cl. CPC H05B 6/6414; H05B 6/6402; H05B 6/6485

(57) ABSTRACT

A heating cooker includes a heating and cooking chamber, a housing, a drawer body, a rack portion, and a pinion. A second opening is formed in a front wall of a housing. A drawer body can be pulled out along a second direction with respect to the heating and cooking chamber. A rack portion is inserted into a second opening and moves along the second direction together with the drawer body. A pinion rotates about an axis along a first direction and meshes with a rack tooth portion. The rack tooth portion is disposed at an end portion in a third direction of the rack portion. The rack portion includes a first wall portion disposed further on one side in the first direction than the rack tooth portion. An end portion on one side in the third direction of the first wall portion is positioned further on one side in the third direction than an end portion on one side in the third direction of the rack tooth portion.

### BACKGROUND OF THE INVENTION

### 1. Technical Field

The present disclosure relates to a heating cooker.

### 2. Description of the Related Art

JP 2008-8562 A discloses a drawer-type heating cooker. The drawer-type heating cooker disclosed in JP 2008-8562 A includes a magnetron that generates microwaves, a heating and cooking chamber, a drawer body that can be put in and taken out of the heating and cooking chamber, and a drive mechanism that drives the drawer body. The drive mechanism includes a pinion gear and a rack tooth portion (rack gear) meshing with the pinion gear.

### SUMMARY OF THE INVENTION

In the drawer body of JP 2008-8562 A, since a tooth tip of the rack tooth portion protrudes, there is a possibility that the tooth tip of the rack tooth portion is damaged.

In view of the above problems, an object of the present disclosure is to provide a heating cooker capable of suppressing breakage of a tooth tip of a rack tooth portion.

According to one aspect of the present disclosure, a heating cooker includes a heating and cooking chamber, a housing, a drawer body, a rack portion, and a pinion. An object to be heated is accommodated in the heating and cooking chamber. The heating and cooking chamber is accommodated in the housing. The housing has a wall portion. An opening is formed in the wall portion. The drawer body can be drawn out along a first direction with respect to the heating and cooking chamber. The rack portion includes a rack tooth portion, extends in the first direction, is inserted into the opening, is connected to the drawer body, and is configured to move along the first direction together with the drawer body. The pinion is configured to rotate about an axis along a second direction intersecting the first direction and mesh with the rack tooth portion. The rack tooth portion is disposed at an end portion of the rack portion in a third direction intersecting the first direction and the second direction. The rack portion includes a first wall portion disposed further on one side or another side in the second direction than the rack tooth portion. An end portion on one side in the third direction of the first wall portion is positioned further on one side in the third direction than an end portion on one side in the third direction of the rack tooth portion.

According to the heating cooker of the present disclosure, it is possible to prevent a tooth tip of the rack tooth portions from being damaged.

### BRIEF DESCRIPTION OF THE DRAWINGS

FIG. 1 is a perspective view of a heating cooker according to an embodiment of the present disclosure;

FIG. 2 is a perspective view of the heating cooker according to the present embodiment;

FIG. 3 is a view illustrating a left side surface of the heating cooker according to the present embodiment;

FIG. 4 is a perspective view illustrating the heating cooker in a state where a housing is removed according to the present embodiment;

FIG. 5 is a perspective view illustrating the heating cooker in a state where the housing is removed according to the present embodiment;

FIG. 6 is a view illustrating a left side surface of the heating cooker in a state where the housing is removed according to the present embodiment;

FIG. 7 is a perspective view illustrating a drive motor, a rack portion, and a pinion;

FIG. 8 is a perspective view illustrating a periphery of a second opening;

FIG. 9 is a front view illustrating a rack tooth portion and a pinion tooth portion; and

FIG. 10 is a view illustrating a variation of the rack portion.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and description of these will not be repeated.

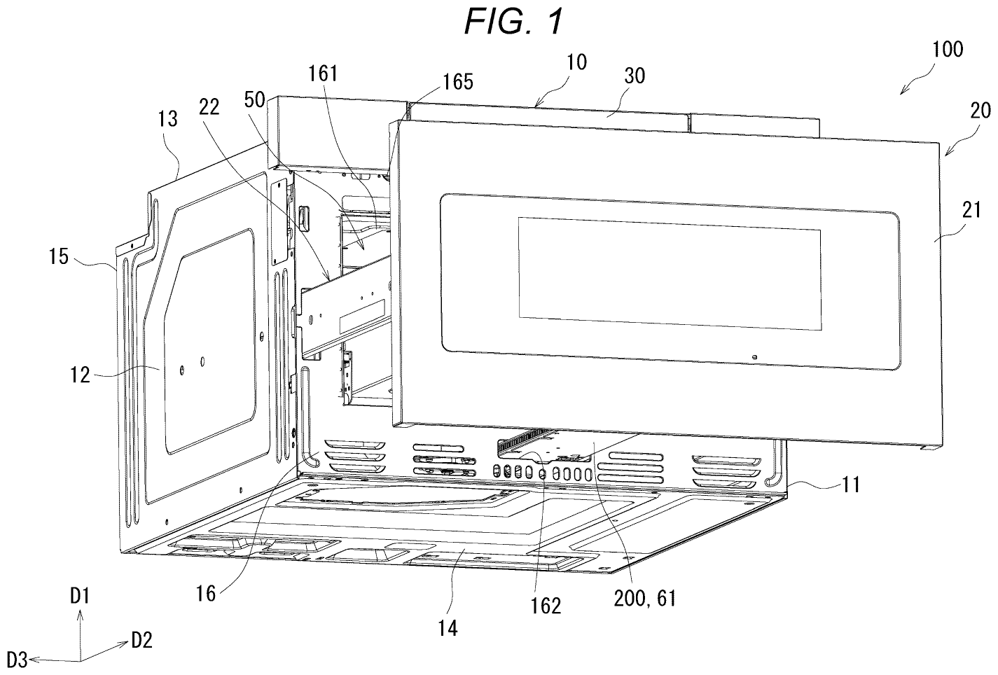

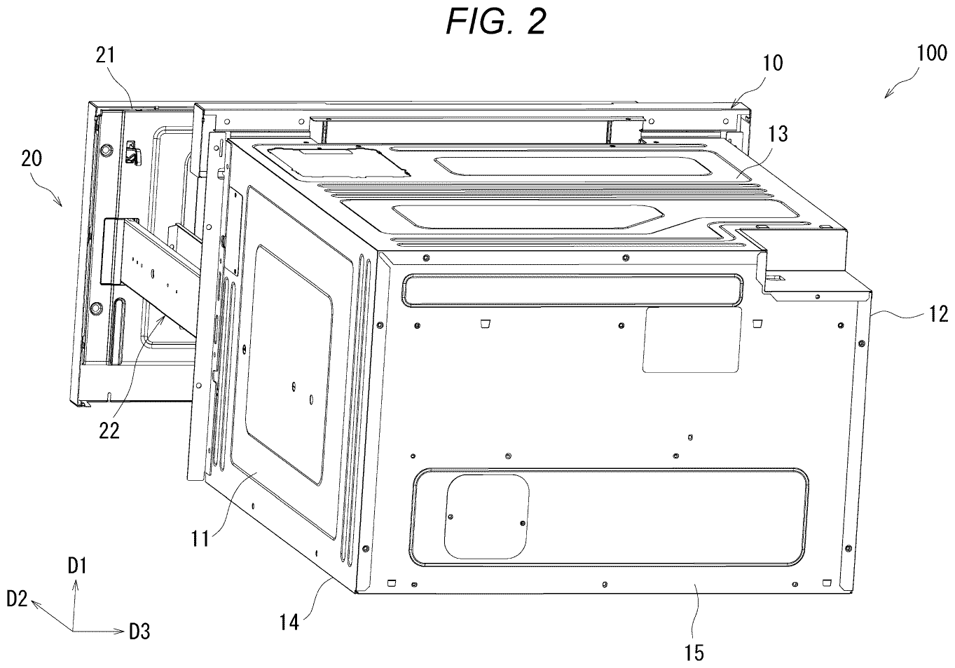

With reference to FIGS. 1 and 2, a heating cooker 100 according to the present embodiment will be described. FIGS. 1 and 2 are perspective views of the heating cooker according to an embodiment of the present disclosure. To be specific, FIG. 1 illustrates the external appearance of the heating cooker 100 when viewed diagonally from the lower left front. FIG. 2 illustrates the external appearance of the heating cooker 100 when viewed diagonally from the upper right rear. As illustrated in FIGS. 1 and 2, the heating cooker 100 is a drawer-type heating cooker. The heating cooker 100 heats and cooks an object to be heated. The object to be heated is, for example, a food item. The heating cooker 100 includes a housing 10, a drawer body 20, and an operation panel 30.

The operation panel 30 is a substantially rectangular plate-shaped member. The operation panel 30 receives operation from the user. The operation includes, for example, a cooking method for heating and cooking an object to be heated. Specifically, the operation panel 30 includes a display unit and a plurality of buttons. The display unit displays various types of information. Specifically, the display unit includes a liquid crystal panel.

In the present embodiment, a side of the heating cooker 100 on which the operation panel 30 is disposed is defined as a front side of the heating cooker 100, and a side (back surface side) opposite to the front side is defined as a rear side of the heating cooker 100. Further, when the heating cooker 100 is viewed from the front side, a right side is defined as a right side of the heating cooker 100, and a side opposite to the right side is defined as a left side of the heating cooker 100. Further, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions are not intended to limit directions when the heating cooker 100 of the present disclosure is used. In the present embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, a rear outer wall 15, a front wall 16. The rear outer wall 15 intersects the second direction D2. The right outer wall 11 and the left outer wall 12 face each other in the third direction D3. The upper outer wall 13 and the lower outer wall 14 face each other in the first direction D1. The housing 10 accommodates a heating and cooking chamber 50 to be described below.

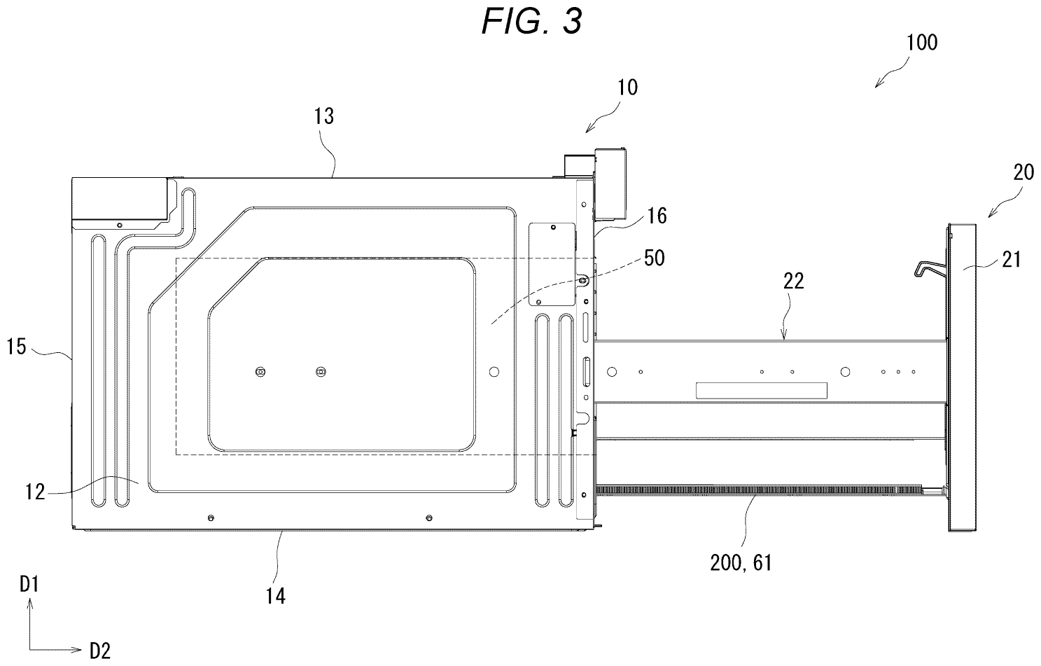

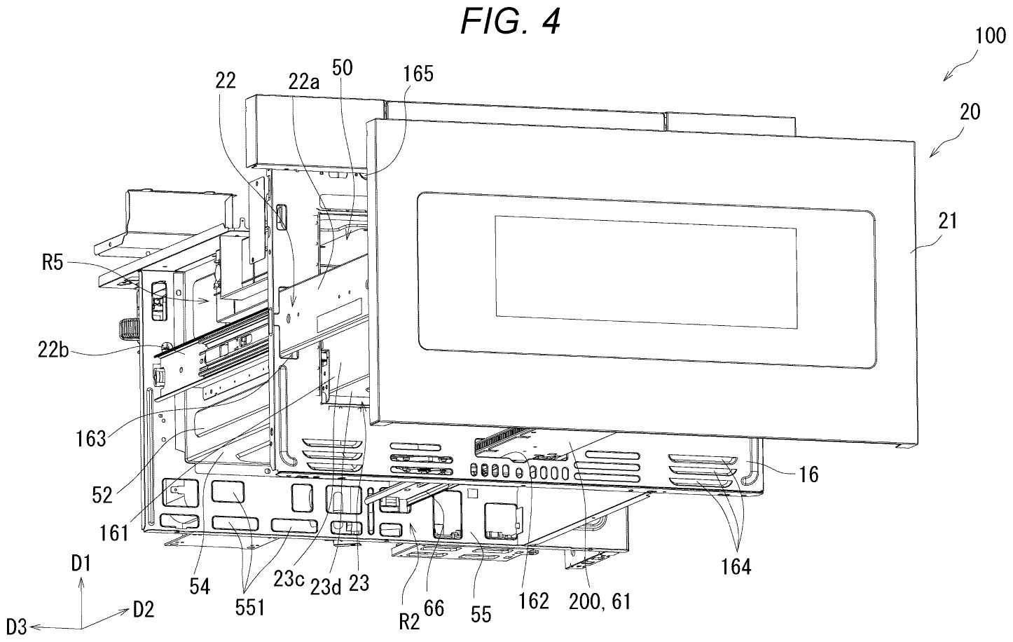

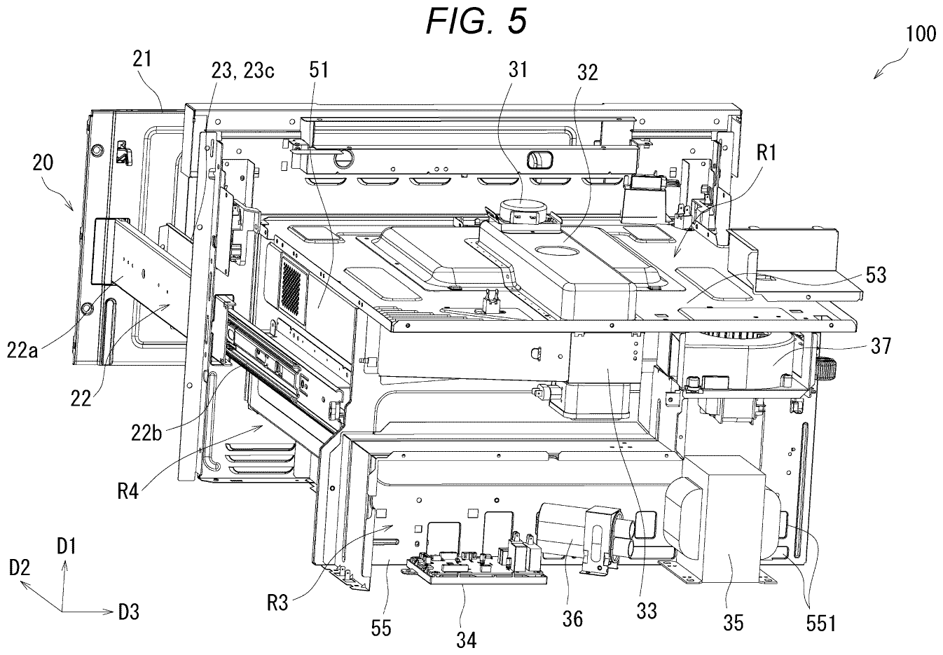

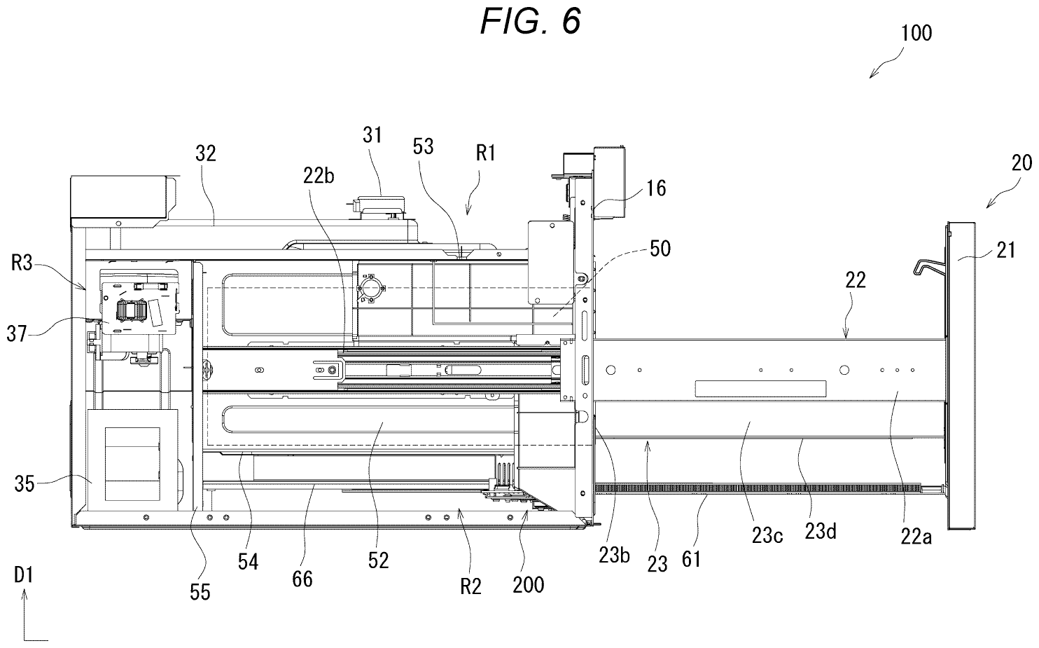

Next, the heating and cooking chamber 50 will be described with reference to FIGS. 3 to 6. FIG. 3 is a view illustrating a left side surface of the heating cooker 100 according to the present embodiment. FIGS. 4 and 5 are perspective views illustrating the heating cooker 100 in a state where the housing 10 is removed according to the present embodiment. To be specific, FIG. 4 illustrates the external appearance of the heating cooker 100 when viewed diagonally from the lower left front. FIG. 5 illustrates the external appearance of the heating cooker 100 when viewed diagonally from the upper right rear. FIG. 6 is a view illustrating a left side surface of the heating cooker 100 in a state where the housing 10 is removed according to the present embodiment.

As illustrated in FIGS. 1 and 3, the heating and cooking chamber 50 is accommodated in the housing 10. The heating and cooking chamber 50 accommodates an object to be heated. The heating and cooking chamber 50 has, for example, a substantially rectangular parallelepiped shape. Specifically, as illustrated in FIGS. 4 to 6, the heating and cooking chamber 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1. A material of each of the right wall 51, the left wall 52, the upper wall 53, the lower wall 54, and the rear wall 55 is, for example, stainless steel. Note that the material of each wall is not limited to stainless steel. Any metal having at least predetermined heat resistance and reflectance characteristics may be used.

A front end of the right wall 51, the left wall 52, the upper wall 53, and the lower wall 54 is connected to a rear surface of the front wall 16. A rear end of the right wall 51, the left wall 52, and the lower wall 54 is connected to a front surface of the rear wall 55. An upper end portion of the rear wall 55 is connected to a lower surface of the upper wall 53, and a lower end portion of the rear wall 55 is connected to an upper surface of the lower wall 54.

As illustrated in FIG. 4, the front wall 16 includes a first opening 161, a second opening 162, a third opening 163, a suction port 164, and a blow-out port 165. In other words, the housing 10 has the front wall 16 in which the first opening 161 and the second opening 162 are formed. The front wall 16 corresponds to, for example, a “wall portion”. Further, the first opening 161 corresponds to, for example, “another opening”, and the second opening 162 corresponds to, for example, an “opening”.

An object to be heated passes through the first opening 161. The first opening 161 is formed in a substantially rectangular shape. The first opening 161 is positioned inside a region defined by a connection portion between the right wall 51, the left wall 52, the upper wall 53, and the lower wall 54, and the front wall 16.

The second opening 162 is positioned at an intermediate position and below the first opening 161 in the left-right direction of the first opening 161. Specifically, the second opening 162 is positioned between the lower outer wall 14 and the lower wall 54. The second opening 162 is formed in a substantially rectangular shape. The second opening 162 includes a notch-shaped opening having no partition portion with respect to the first opening 161.

For example, a pair of left and right ones of the third openings 163 are provided. A pair of the third openings 163 are disposed at a position corresponding to an intermediate position of the first opening 161 in an up-down direction. Specifically, the third opening 163 is disposed between the upper outer wall 13 and the lower outer wall 14. Further, a pair of the third openings 163 are positioned with the first opening 161 interposed between them in the third direction D3. Note that the third opening 163 includes a notch-shaped opening having no partition portion with respect to the first opening 161.

Air passes through the suction port 164 from the outside of the housing 10 toward the inside of the housing 10. For example, a plurality of the suction ports 164 are provided. A plurality of the suction ports 164 are disposed at a lower position of the first opening 161 and a lower position of the second opening 162.

Air passes through the blow-out port 165 from the inside of the housing 10 toward the outside of the housing 10. For example, a plurality of the blow-out ports 165 are provided. A plurality of the blow-out ports 165 is disposed at an upper position than the first opening 161.

As illustrated in FIGS. 4 and 5, the rear wall 55 has a fourth opening 551. Air flowing in through the suction port 164 passes through the fourth opening 551 to the rear side of the rear wall 55. For example, a plurality of the fourth openings 551 are provided. The fourth opening 551 is disposed at a corresponding position between the lower outer wall 14 and the lower wall 54.

As illustrated in FIGS. 4 to 6, the heating cooker 100 further includes a first space R1, a second space R2, a third space R3, a fourth space R4, and a fifth space R5. The second space R2 is disposed between the lower outer wall 14 and the lower wall 54. The fourth space R4 is disposed between the right outer wall 11 and the right wall 51. The fifth space R5 is disposed between the left outer wall 12 and the left wall 52.

As illustrated in FIGS. 5 and 6, the first space R1 is positioned between the upper outer wall 13 and the upper wall 53. In the first space R1, a motor 31 and a waveguide 32 are disposed. The motor 31 rotates an antenna of a magnetron 33 that is a microwave generation device. The waveguide 32 propagates microwaves generated by the magnetron 33. The heating cooker 100 executes a microwave heating mode by operation of the magnetron 33.

The third space R3 is disposed between the rear outer wall 15 and the rear wall 55. The magnetron 33, a control board 34, a high-voltage transformer 35, a high-voltage capacitor 36, and a cooling fan 37 are disposed in the third space R3. The control board 34, the high-voltage transformer 35, and the high-voltage capacitor 36 are fixed to an upper portion of the lower outer wall 14 along the third direction D3. The cooling fan 37 is disposed above the high-voltage transformer 35 adjacent to the left outer wall 12. The cooling fan 37 sucks air from the suction port 164 into the second space R2. Air sucked into the second space R2 flows into the third space R3 through the fourth opening 551. Air flowing into the third space R3 cools electric components such as the high-voltage transformer 35, and a part of the air passes through the heating and cooking chamber 50, is sent to the first space R1, and is blown out of the housing 10 through the blow-out port 165.

Next, the drawer body 20 will be described with reference to FIGS. 1 to 6. The drawer body 20 can be pulled out from the heating and cooking chamber 50. The drawer body 20 opens the first opening 161 by movement in the second direction D2, and closes the first opening 161 by movement in a direction opposite to the second direction D2. As illustrated in FIGS. 1 to 6, the drawer body 20 includes a door 21, left and right slide portions 22, a lower slide portion 61, and a placement portion 23. The second direction D2 corresponds to, for example, “one side in the first direction”. A direction opposite to the second direction D2 corresponds to, for example, “another side in the first direction”.

The door 21 is configured to be able to open and close the first opening 161. The suction port 164 and the blow-out port 165 are open also in a state where the door 21 closes the first opening 161.

As illustrated in FIGS. 4 to 6, the slide portion 22 includes a movable rail 22a and a fixed rail 22b. The slide portion 22 is a telescopic slide mechanism in which the movable rail 22a is slidable with respect to the fixed rail 22b.

For example, a pair of the fixed rails 22b are provided on the left and right. A pair of the fixed rails 22b are disposed in each of the fourth space R4 and the fifth space R5. A pair of the fixed rails 22b are fixed to an outer surface of the right wall 51 and an outer surface of the left wall 52. Specifically, the fixed rail 22b is disposed along the second direction D2 at an intermediate position in the up-down direction of the right wall 51 (left wall 52).

For example, a pair of the movable rails 22a are provided on the left and right. Front end portions of a pair of the movable rails 22a are connected to a rear surface of left and right end portions of the door 21. A pair of the movable rails 22a extend in the second direction D2 and is inserted into a pair of the third openings 163. When the drawer body 20 is completely pulled out from the heating and cooking chamber 50, length of the movable rail 22a extending from the third opening 163 in the second direction D2 is longest. The first opening 161 is opened. On the other hand, when the drawer body 20 is completely pulled into the heating and cooking chamber 50, length of the movable rail 22a extending from third opening 163 in second direction D2 is shortest. The first opening 161 is closed by the door 21.

An object to be heated is placed on the placement portion 23. The placement portion 23 includes a rear wall portion 23b, left and right side wall portions 23c, and a bottom wall portion 23d. Front end portions of the left and right side wall portions 23c are connected to a rear surface of the door 21, and rear end portions of the left and right side wall portions 23c are connected to a front surface of the rear wall portion 23b. Lower end portions of the left and right side wall portions 23c and the rear wall portion 23b are connected to the bottom wall portion 23d. Further, the placement portion 23 is connected to the movable rail 22a via the door 21. Therefore, when the movable rail 22a is pulled out from the third opening 163, the placement portion 23 is pulled out from the heating and cooking chamber 50 in the second direction D2 along with movement of the movable rail 22a.

The heating cooker 100 further includes a moving mechanism 200. The moving mechanism 200 moves the drawer body 20 forward and backward along the second direction D2.

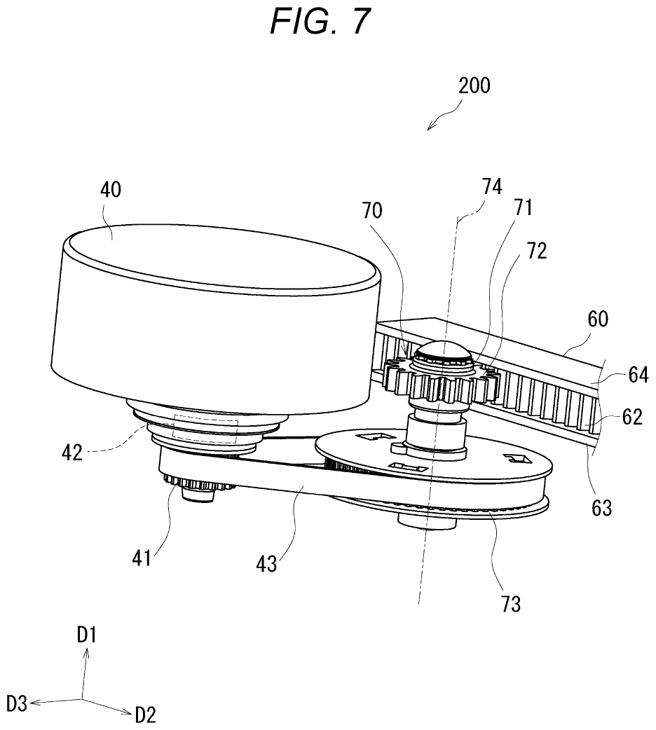

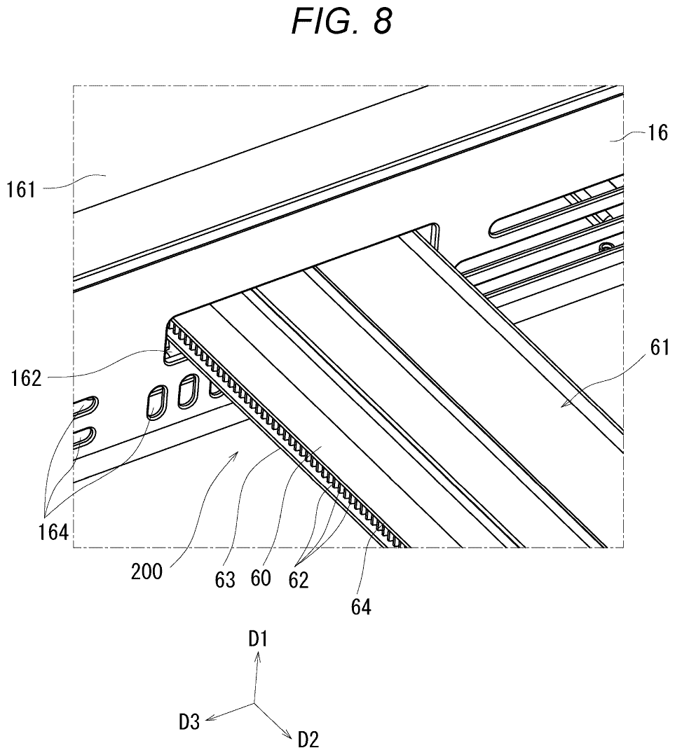

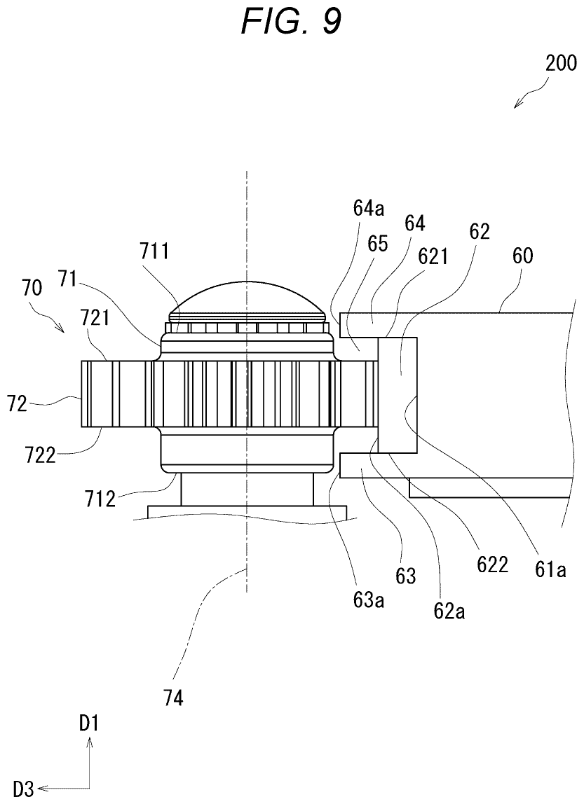

The moving mechanism 200 will be described with reference to FIGS. 7 to 9. FIG. 7 is a perspective view illustrating a drive motor 40, a rack portion 60, and a pinion 70. FIG. 8 is a perspective view illustrating a periphery of the second opening 162. FIG. 9 is a front view illustrating a rack tooth portion 62 and a pinion tooth portion 72. The moving mechanism 200 includes the drive motor 40, the rack portion 60, and the pinion 70.

The rack portion 60 moves along the front-rear direction together with the drawer body 20. As illustrated in FIGS. 1, 4, and 8, the lower slide portion 61 having the rack portion 60 extends along the front-rear direction and is inserted into the second opening 162. A front end portion of the slide portion 61 is connected to a rear surface of a lower portion of the door 21 at a center portion in the left-right direction. In other words, the slide portion 61 having the rack portion 60 is connected to the drawer body 20. As illustrated in FIGS. 7 to 9, the rack portion 60 includes the rack tooth portion 62 and a first wall portion 63.

The rack tooth portion 62 is disposed at an end portion of the rack portion 60 in the left-right direction. A plurality of the rack tooth portions 62 are provided at an end portion 61a of the slide portion 61 described later in the third direction D3. The rack tooth portion 62 extends in the third direction D3 from the end portion 61a of the slide portion 61 in the third direction D3. A plurality of the rack tooth portions 62 are aligned along the second direction D2.

The pinion 70 meshes with the rack tooth portion 62. The pinion 70 rotates about an axis 74 along the up-down direction.

The first wall portion 63 is disposed at an end portion of the rack portion 60 in the third direction D3. The first wall portion 63 is disposed on one side or another side of the rack tooth portion 62 in the up-down direction. Specifically, the first wall portion 63 is disposed at a position opposite to the rack tooth portion 62 in the first direction D1. Note that the first direction D1 corresponds to, for example, “one or another side of the second direction”.

An end portion 63a on one side in the left-right direction of the first wall portion 63 is positioned further on one side in the left-right direction than an end portion 62a on one side in the left-right direction of the rack tooth portion 62. Specifically, the end portion 63a in the third direction D3 of the first wall portion 63 is positioned further in the third direction D3 than the end portion 62a in the third direction D3 of the rack tooth portion 62. Since the end portion 63a in the third direction D3 of the first wall portion 63 is positioned further in the third direction D3 than the end portion 62a in the third direction D3 of the rack tooth portion 62, it is possible to prevent the end portion 62a in the third direction D3 of the rack tooth portion 62 from protruding in the third direction D3 from the end portion 63a in the third direction D3 of the first wall portion 63. By the above, the rack tooth portion 62 can be prevented from being damaged.

The lower slide portion 61 includes the rack portion 60, a movable rail, and a fixed rail. The slide portion 61, the movable rail, and the fixed rail are made from metal. The rack portion 60 includes the rack tooth portion 62, the first wall portion 63, and a second wall portion 64. The rack portion 60 is made from synthetic resin and may be integrally formed. In the present embodiment, slide portions are disposed on both the left and right sides and on the lower side, and the rack portion 60 is disposed on the lower slide portion 61, but the configuration is not limited to this. The rack portion 60 may be provided on at least one of the left and right slide portions 22. Note that, in consideration of balanced forward and backward movement, it is preferable to arrange the rack portion 60 on the lower slide portion 61.

As illustrated in FIGS. 7 to 9, the lower slide portion 61 extends along the second direction D2. The slide portion 61 is formed from a plate-like member. The slide portion 61 moves along a slide rail 66 (see FIG. 6). As illustrated in FIG. 6, the slide rail 66 is fixed in a state of being stretched between the front wall 16 and the rear wall 55 along the second direction D2.

As illustrated in FIGS. 7 to 9, the rack tooth portion 62, the first wall portion 63, and the second wall portion 64 are provided at an end portion of the slide portion 61 in the third direction D3. The slide portion 61 constitutes a groove portion 65 together with the first wall portion 63 and the second wall portion 64.

The second wall portion 64 is disposed opposite to the first wall portion 63 with respect to the rack tooth portion 62. Specifically, the second wall portion 64 is disposed with the rack tooth portion 62 interposed between the first wall portion 63 and the second wall portion 64. An end portion 64a in the third direction D3 of the second wall portion 64 is positioned further in the third direction than the end portion 62a in the third direction D3 of the rack tooth portion 62. In the present embodiment, the end portion 63a of the first wall portion 63 and the end portion 64a of the second wall portion 64 are positioned at the same position in the third direction D3. As described above, the rack tooth portion 62 can be accommodated in the groove portion 65 formed by the first wall portion 63 and the second wall portion 64. By the above, the end portion 62a in the third direction D3 of the rack tooth portion 62 can be prevented from protruding in the third direction D3 from the end portion 63a in the third direction D3 of the first wall portion 63, and the end portion 62a in the third direction D3 of the rack tooth portion 62 can be prevented from protruding in the third direction D3 from the end portion 64a in the third direction D3 of the second wall portion 64. Accordingly, it is possible to further prevent the rack tooth portion 62 from being damaged.

As illustrated in FIGS. 4 and 6, the rack portion 60 is disposed below the placement portion 23. Since the rack portion 60 is disposed below the placement portion 23, it is possible to prevent approach from the placement portion 23 side to the rack tooth portion 62 by being blocked by the placement portion 23. As a result, damage to the rack tooth portion 62 can be suppressed. Since the rack portion 60 is disposed below the placement portion 23, the rack portion 60 is blocked by the placement portion 23 and is not visible to the user. As a result, deterioration in appearance can be suppressed.

As illustrated in FIGS. 7 to 9, the first wall portion 63 is disposed below the rack tooth portion 62. The placement portion 23 can prevent approach toward the rack tooth portion 62 from above, and the first wall portion 63 can prevent approach toward the rack tooth portion 62 from below.

The rack tooth portion 62 is disposed at the end portion 61a of the slide portion 61 in a horizontal direction. Since an upper surface of the rack portion 60 can be disposed to face the bottom wall portion 23d of the placement portion 23, approach to the rack tooth portion 62 from above can be further prevented. Further, since the rack portion 60 and the bottom wall portion 23d are disposed close to each other, the heating cooker 100 can be downsized. The rack portion 60 is driven by the drive motor 40.

As illustrated in FIG. 7, the drive motor 40 includes a first pulley 41 and a clutch unit 42. The drive motor 40 is disposed in the second space R2, for example, and is fixed to a rear surface of the front wall 16. For example, in a case where an opening operation button (not illustrated) of the operation panel 30 is turned on, the drive motor 40 moves the drawer body 20 by forward rotation to open the first opening 161. For example, in a case where a closing operation button (not illustrated) of the operation panel 30 is turned on, the drive motor 40 moves the drawer body 20 by reverse rotation to close the first opening 161.

The first pulley 41 is fixed to a tip of a drive shaft of the drive motor 40. Specifically, the first pulley 41 is fixed to a lower end of the drive shaft of the drive motor 40. The first pulley 41 transmits driving force to the pinion 70 via a belt 43.

The clutch unit 42 transmits or cuts off driving force from the drive motor 40 toward the first pulley 41. The clutch unit 42 is disposed between a motor main body and the first pulley 41. For example, when an opening operation button of the operation panel 30 is turned on, since the clutch unit 42 is connected, driving force is transmitted from the drive motor 40 to the first pulley 41. The clutch unit 42 is cut off at a timing when pull-out of the drawer body 20 is completed, and driving force from the drive motor 40 toward the first pulley 41 is cut off. For example, when a close operation button of the operation panel 30 is turned on, the clutch unit 42 is connected, so that driving force is transmitted from the drive motor 40 to the first pulley 41. In the clutch unit 42, the clutch unit 42 is cut off at a timing when pull-in of the drawer body 20 is completed, and driving force from the drive motor 40 toward the first pulley 41 is cut off. Here, the drive motor 40 does not need to include the clutch unit 42. In a case where the drive motor 40 does not include the clutch unit 42, for example, when an opening operation button of the operation panel 30 is turned on, a drive shaft of the drive motor 40 is operated, and the drive shaft of the drive motor 40 only needs to be stopped at a timing when pull-out of the drawer body 20 is completed. For example, the same applies when a closing operation button of the operation panel 30 is turned on.

The pinion 70 transmits driving force input to a second pulley 73 via the belt 43 to the rack portion 60. A spline formed on an inner periphery of the pinion 70 is engaged with a spline formed on a rotation shaft of the second pulley 73. Specifically, the pinion 70 is connected to an upper portion of a rotation shaft extending upward from the second pulley 73.

The pinion 70 is made from metal. Since the rack portion 60 is made from synthetic resin, the rack portion 60 can elastically deform to follow the pinion 70. By the above, it is possible to suppress squeaking noise generated at the time of meshing between the pinion 70 and the rack portion 60 while suppressing tooth skipping of the pinion 70. However, the pinion 70 may be made from synthetic resin.

As illustrated in FIGS. 7 and 9, the pinion 70 includes a shaft portion 71 and the pinion tooth portion 72.

The pinion tooth portion 72 extends radially outward from the shaft portion 71 and meshes with the rack tooth portion 62. An upper end portion 721 of the pinion tooth portion 72 is positioned below an upper end portion 621 of the rack tooth portion 62. A lower end portion 722 of the pinion tooth portion 72 is positioned above a lower end portion 622 of the rack tooth portion 62. By the above, during opening operation of the drawer body 20, it is possible to suppress interference between the pinion tooth portion 72 and the first wall portion 63 or the second wall portion 64, and it is possible to suppress generation of sound caused by the interference.

An upper end portion 711 of the shaft portion 71 is positioned above an upper end portion 621 of the rack tooth portion 62. A lower end portion 712 of the shaft portion 71 is positioned below a lower end portion 622 of the rack tooth portion 62. By the above, rigidity of the shaft portion 71 can be increased by enlarging the shaft portion 71, so that a posture of the pinion 70 can be maintained and occurrence of tooth skipping can be suppressed.

The embodiment of the present disclosure is described above with reference to the drawings (FIGS. 1 to 9). However, the present disclosure is not limited to the above embodiment, and can be implemented in various aspects without departing from the gist of the present disclosure (for example, (1) to (7) described below). For easy understanding, the drawings schematically illustrate each constituent element mainly, and thickness, length, the number, and the like of constituent elements illustrated in the drawings are different from actual ones for convenience of preparation of the drawings. Further, materials, shapes, dimensions, and the like of constituent elements illustrated in the above embodiment are merely examples, and are not particularly limited, and various modifications can be made without substantially departing from the effects of the present disclosure.
(1) As described with reference to FIGS. 1 to 9, the rack tooth portion 62 is disposed on one side in the horizontal direction, and a surface portion of the rack portion 60 intersects a vertical direction. However, the present disclosure is not limited to this. The rack portion 60 may be disposed such that the rack tooth portion 62 is arranged on one side in the vertical direction and a surface portion of the rack portion 60 intersects the horizontal direction.
(2) As described with reference to FIGS. 1 to 9, the rack portion 60 is disposed such that a surface portion of the rack portion 60 faces the bottom wall portion 23d of the placement portion 23. However, the present disclosure is not limited to this. The rack portion 60 may be disposed such that a surface portion of the rack portion 60 faces the side wall portion 23c of the placement portion 23.
(3) As described with reference to FIGS. 1 to 9, the drive motor 40 is fixed to a rear surface of the front wall 16, and the first pulley 41 is fixed to a lower end of a drive shaft of the drive motor 40, but the present disclosure is not limited to this. The drive motor 40 may be fixed to an upper surface of the lower outer wall 14, and the first pulley 41 may be fixed to an upper end of a drive shaft of the drive motor 40. With this configuration, the second pulley 73 is rotated by the first pulley 41 fixed to an upper end of a drive shaft of the drive motor 40, and the pinion 70 connected to an upper portion of a rotation shaft extending upward from the second pulley 73 is rotated.
(4) As described with reference to FIGS. 1 to 9, the end portion 63a of the first wall portion 63 and the end portion 64a of the second wall portion 64 are positioned at the same position in the third direction D3, but the present disclosure is not limited to this. The end portion 63a of the first wall portion 63 and the end portion 64a of the second wall portion 64 may be positioned at different positions in the third direction D3.

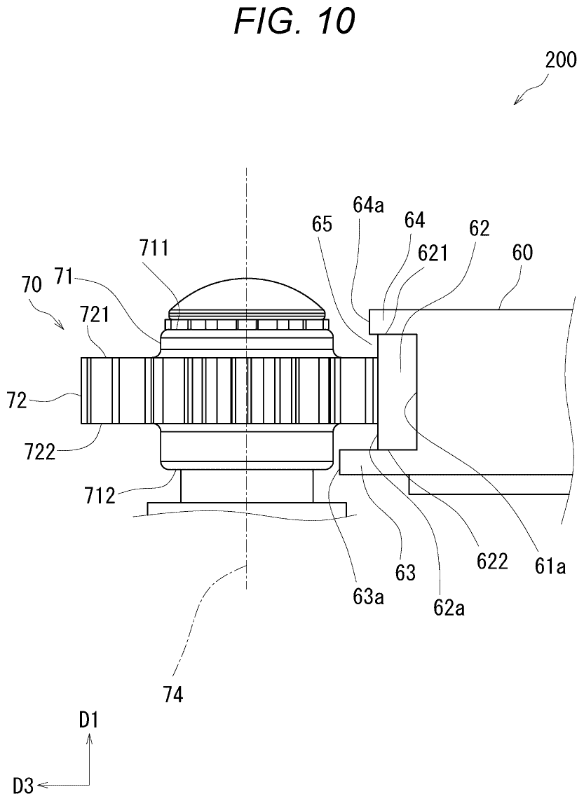

As illustrated in FIG. 10, the end portion 63a in the third direction D3 of the first wall portion 63 disposed lower between the first wall portion 63 and the second wall portion 64 may be positioned further in the third direction D3 than the end portion 64a in the third direction D3 of the second wall portion 64. With this configuration, since the end portion 63a in the third direction D3 of the first wall portion 63 is positioned further in the third direction D3 than the end portion 64a in the third direction D3 of the second wall portion 64, the second wall portion 64 can be made small while catching of a finger and the like is suppressed. As a result, the rack portion 60 can be downsized.
(5) As described with reference to FIGS. 1 to 9, the rack tooth portion 62, the first wall portion 63, and the second wall portion 64 are formed as a single member, but the present disclosure is not limited to this. The rack tooth portion 62, the first wall portion 63, and the second wall portion 64 may be formed as separate members, and these members may be connected via a connection member. Further, at least any of the rack tooth portion 62, the first wall portion 63, and the second wall portion 64 may be made from metal. For example, the rack tooth portion 62 and the second wall portion 64 may be formed as a single member, an end portion on one side in the third direction D3 of the slide portion 61 may be positioned further on one side in the third direction D3 than an end portion on one side in the third direction D3 of the rack tooth portion 62, and at least a part of the slide portion 61 may be the first wall portion 63. Further, the rack tooth portion 62 and the first wall portion 63 may be formed as a single member, and an end portion on one side in the third direction D3 of the slide portion 61 may be positioned further on one side in the third direction D3 than an end portion on one side in the third direction D3 of the rack tooth portion 62, so that at least a part of the slide portion 61 is configured to be the second wall portion 64.
(6) As described with reference to FIGS. 1 to 9, the lower slide portion 61 is configured to include the rack portion 60, but the present disclosure is not limited to this. At least one of the left and right slide portions 22 may be configured to have a rack portion. The moving mechanism 200 only needs to be configured to support the rack portion 60.
(7) As described with reference to FIGS. 1 to 9, the heating cooker 100 performs only a microwave heating mode as a heating cooking mode, but the present disclosure is not limited to this. The heating cooker 100 may execute other cooking modes such as a grill heating mode and a hot air circulation heating mode in addition to the microwave heating mode as the heating cooking mode. The grill heating mode is a mode for heating and cooking an object to be heated mainly by exposing the object to be heated to radiant heat. The hot air circulation heating mode is a mode for heating and cooking an object to be heated mainly by circulating hot air in the inside of the heating and cooking chamber 50 to achieve uniform temperature in the heating and cooking chamber 50.

The present disclosure is useful, for example, in the field of heating cookers.

What is claimed is:

1. A heating cooker comprising:
a heating and cooking chamber in which an object to be heated is accommodated;
a housing in which the heating and cooking chamber is accommodated, the housing having a wall portion in which an opening is formed;
a drawer body that can be pulled out along a first direction with respect to the heating and cooking chamber;
a rack portion that has a rack tooth portion, extends in the first direction, is inserted into the opening, is connected to the drawer body, and is configured to move along the first direction together with the drawer body; and
a pinion configured to rotate about an axis along a second direction intersecting the first direction and mesh with the rack tooth portion, wherein
the rack tooth portion is disposed at an end portion in a third direction intersecting the first direction and the second direction of the rack portion,
the rack portion includes a first wall portion disposed further on one side or another side in the second direction than the rack tooth portion, and
an end portion on one side in the third direction of the first wall portion is positioned further on one side in the third direction than an end portion on one side in the third direction of the rack tooth portion.

2. The heating cooker according to claim 1, wherein
the rack portion includes a second wall portion disposed at a position opposite to the first wall portion with respect to the rack tooth portion, and
an end portion on one side in the third direction of the second wall portion is positioned further on one side in the third direction than an end portion on one side in the third direction of the rack tooth portion.

3. The heating cooker according to claim 2, wherein
the pinion includes:
a shaft portion; and
a pinion tooth portion that extends radially outward from the shaft portion and is configured to mesh with the rack tooth portion,
an end portion on one side in the second direction of the shaft portion is positioned further on one side in the second direction than an end portion on one side in the second direction of the rack tooth portion,
an end portion on another side in the second direction of the shaft portion is positioned further on another side in the second direction than an end portion on another side in the second direction of the rack tooth portion,
an end portion on one side in the second direction of the pinion tooth portion is positioned further on another side in the second direction than an end portion on one side in the second direction of the rack tooth portion, and
an end portion on another side in the second direction of the pinion tooth portion is positioned further on one side in the second direction than an end portion on another side in the second direction of the rack tooth portion.

4. The heating cooker according to claim 1, wherein
the wall portion further includes another opening different from the opening,
the drawer body includes:
a door configured to be capable of opening and closing the another opening; and
a placement portion on which the object to be heated is placed, and
the rack portion is disposed below the placement portion.

5. The heating cooker according to claim 2, wherein
the drawer body includes:
a placement portion on which the object to be heated is placed; and
a slide portion disposed below the placement portion, and
the rack tooth portion is disposed at an end portion in a horizontal direction of the slide portion.

6. The heating cooker according to claim 4, wherein
the second direction indicates a direction along a vertical direction, and
the first wall portion is disposed below the rack tooth portion.

7. The heating cooker according to claim 4, wherein
the rack portion includes a second wall portion disposed opposite to the first wall portion with respect to the rack tooth portion,
an end portion on one side in the third direction of the second wall portion is positioned further on one side in the third direction than an end portion on one side in the third direction of the rack tooth portion, and
an end portion on one side in the third direction of one wall portion disposed lower between the first wall portion and the second wall portion is positioned further on one side in the third direction than an end portion on one side in the third direction of another wall portion.

8. The heating cooker according to claim 1, wherein
the pinion is made from metal, and
the rack portion is made from synthetic resin.
